(19) United States
(12) Patent Application Publication
(10) Pub. No.: US 2010/0131710 A1
(43) Pub. Date: May 27, 2010

(54) METHOD AND APPARATUS FOR SHARING CONTENT BETWEEN PORTALS

(75) Inventor: Ohad YASSIN, Herzeliya (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: SAP Portals Israel Ltd, Raanana (IL)

(21) Appl. No.: 12/276,426

(22) Filed: Nov. 24, 2008

(51) Int. Cl. G06F 15/16; G06F 12/08

(52) U.S. Cl. 711/118; 709/219; 711/E12.017

(57) ABSTRACT

A method and apparatus for enabling a first portal to receive and present or otherwise use content from a second portal. The first portal comprises an indication to a location within the second portal. During execution of the first portal, the indication, such as a shortcut is parsed, a connection between the first portal and the second portal is created, and requests and responses related to the content are exchanged between the first and the second portal. The shortcuts enable the loose coupling between the portals and avoid the need for managing multiple versions of the component providing the data or tight coupling In addition, the method and apparatus enable the execution of a non-executable unit of the second portal from an environment of the first portal. The method and apparatus can be used in a transitive manner, such that a first portal will use content from a second portal, which in turn uses content from a third portal.

### TECHNICAL FIELD

The present disclosure relates to web portals in general, and to a method and apparatus for sharing content between portals, in particular.

### BACKGROUND

A web portal is a web site that provides a single access point providing a user with a multiplicity of services and information. Web portals may present information from diverse sources in a unified way, and provide additional services, such as an internal search engine, e-mail, news, and various other features. Portals are often used by enterprises for providing their employees, customers and possibly additional users with a consistent look and feel, and access control and procedures for multiple applications, which otherwise would have been different entities altogether.

Some organizations may maintain a number of portals, wherein each portal is intended for different users, based upon their geographic location, roles, areas of interest or other factors. For example, a media source may offer one portal to the public and different portals to its employees, subsidiaries workers, partners or other entities. Each portal may thus contain and provide its users with different functionalities and services.

However, some functionalities may be required by multiple portals, for example an organization directory may be required for all enterprise employees, regardless of which portal they use. With existing techniques, each portal must maintain and provide its own version of the application or service, thus wasting storage and maintenance resources, and risking update inconsistencies. If a service or an application is updated, it has to be installed and deployed by each portal separately. Such application being installed in one portal cannot be consumed by users of other portals.

A mechanism of delta linking relates to the problem, but since this mechanism implies tight coupling between an executable unit and its content the practical effect is of copying the content, so that two or more components coexist in an organization, which gives rise to compatibility problems.

Thus there is a need in the art for a method and apparatus that enable one portal to consume content deployed within another portal, so that users of multiple portals can use the same service, application or another unit.

### SUMMARY

A system and method for utilizing within one portal, content from a second portal, without replicating the content.

In one aspect of the disclosure there is thus provided a method for utilizing within a first portal, content from a second portal in a portal environment, the method comprising: fetching from the first portal a shortcut associated with the second portal; parsing the shortcut to retrieve the second portal and the content location; opening a connection between the first portal and the second portal; sending a request to the second portal via the connection; receiving a response from the second portal, the response associated with the content; and presenting data retrieved from the response. The method can further comprise a step of preparing the request to be sent to the second portal. The method can further comprise the steps of: executing a part the second portal to retrieve the content; preparing the response associated with the content; and sending the response to the first portal. The method can further comprise the step of post-processing the response. Within the method, post processing optionally comprises deserializing the response. Within the method, the response is optionally a TCP response or a UDP response or a derivative thereof. Within the method, the response is optionally an HTTP response, an HTTPs response, RMI response, RPC response, or a SOAP response. Within the method, the first portal optionally presents the data as part of an executable unit. The method can further comprise a caching step for storing the response in cache memory. The method can further comprise a step of determining whether the response is available in cache memory. The method can further comprise a security handling step for determining secure protocol for communication between the first computing platform executing the first portal and a second computing platform executing the second portal. Within the method, the response is optionally prepared by the second portal using the steps of: fetching from the second portal a shortcut associated with a third portal; parsing the shortcut to retrieve the third portal and the content location; opening a second connection between the second portal and the third portal; sending a request to the third portal via the second connection; and receiving a response from the third portal, the response associated with the content.

Another aspect of the disclosure relates to an apparatus for utilizing within a first portal, content from a second portal, the apparatus comprising: within the second portal a part providing the content; within the first portal, an executable unit, the executable unit comprising an indication to the second portal; a shortcut parser component for parsing the indication to the second portal; and a connection creator component for creating a connection between the first portal and the second portal for sending and receiving requests and responses related to the content. Within the apparatus, the connection is optionally a TCP connection or a UDP connection. Within the apparatus, the connection is optionally an RMI connection, an RPC connection, or a SOAP connection.

Yet another aspect of the disclosure discloses within a portal, an indication to a component providing content to be displayed by the portal, the indication being a shortcut indicating a second portal providing the content.

Yet another aspect of the disclosure relates to a computer readable storage medium containing a set of instructions for a general purpose computer, the set of instructions comprising: fetching from a first portal a shortcut associated with content to be displayed by the first portal; parsing the shortcut to retrieve a second portal and the content location; opening a connection between the first portal and the second portal; sending a request to the second portal via the connection; receiving a response from the second portal, the response associated with the content; and presenting data retrieved from the response.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 is a schematic illustration of a typical environment in which the disclosure is used; and

FIG. 2 is a flowchart of the main steps in a method according to the disclosure.

### DETAILED DESCRIPTION

The disclosure relates to U.S. patent application Ser. No. 11/781,426, titled “TECHNIQUES FOR SHARING CONTENT BETWEEN PORTALS” filed on Jul. 23, 2007, the full contents of which are incorporated herein by reference.

A portal typically comprises one or more programs retrieving data from one or more sources and presenting data in a content area of the portal, for example as part of a web page. Such programs are often termed views.

The portal content is organized in units, which are semantic objects such as a view or a page that can be independently accessed and executed, for example by an administrator. A unit may be an atomic unit, which us the smallest applicative component that can be executed and has meaning, including for example state, business logic or other aspects. Thus, an atomic unit can not contain another atomic unit. An atomic unit can be for example an iView or a portlet. A unit optionally comprises one or more sub-units which cannot be independently executed bur rather represent an aspect of the unit, for example business logic, which cannot be executed due to lack of context. Thus, an iView can be created and accessed autonomously, but can not be accessed as part of another view.

Some tasks within a portal can be performed only on units and not on sub-units. For example, permissions are assigned to units and are inherited by sub-units from their parent unit, caching is only performed on unit objects, or the like.

A method and apparatus are disclosed for sharing content and services between portals, by creating loose coupling between a portal and content thereof. In order to use content from a different source within a unit of a portal, a shortcut is created within the unit, which points at a component the remote portal. Updating the content pointed at will update the content for all consumers. On the other hand, changing the shortcut will point at different content if required. Further, the old and the new shortcuts can be used side by side. Upon requirement for the content, the portal or another component, such as a portal framework, accesses the content provider and constructs the content. The content construction can be performed either on the local portal or on the remote portal, regardless of whether the content is a unit or not.

The shortcut can be provided using a structure resolved by using naming convention which relates a string to a portal and component thereof, or by using Universal Resource Identifiers (URLs). This mechanism provides the flexibility of loose coupling between portals, as well as executing sub-unit components belonging to another portal.

It will be appreciated by a person skilled in the art that the content and services sharing can be applied transitively, i.e., a first portal can use a sub-unit produced by a third portal, via a second portal. The transitivity can also be applied further to using content from a fourth, fifth and additional portals.

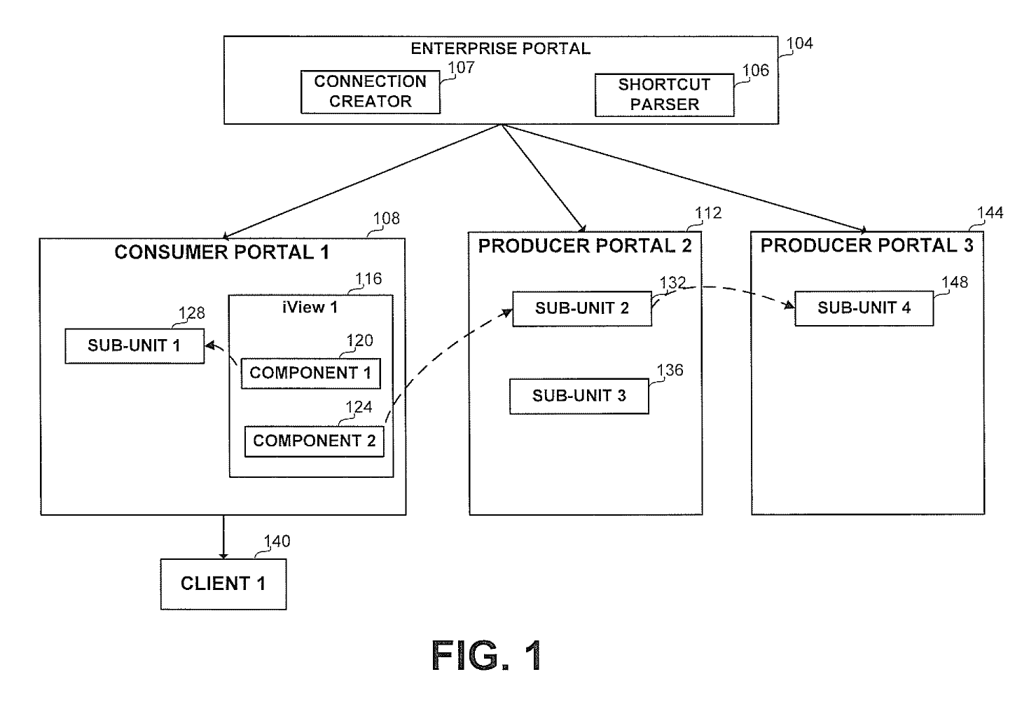

Referring now to FIG. 1, showing an apparatus according to the disclosure. The apparatus comprises an enterprise portal 104, managing various portals in the environment, such as consumer portal 1 (108) and producer portal 2 (112). Consumer portal 1 (108) consumes services or sub0units produced or otherwise provided by producer portal 2 (112). It will be appreciated by a person skilled in the art that enterprise portal 104, consumer portal 1 (108) and producer portal 2 (112) can be implemented on one computing platform or on multiple computing platforms. Each computing platform can be a server, a desktop computer, a laptop computer or any other computing platform provisioned with a Central Processing Unit (CPU) and memory. Each portal, such as consumer portal 1 (108) is accessed by one or more users using computing platforms, such as client 1 (140) which can also be any computing platform provisioned with a CPU and memory. Consumer portal 1 (108) has as part thereof one or more units, such as iView 1 (116), which is executed by the server executing portal 1. iView 1 (116) comprises two sub-units, being component 1 (120) and component 2 (124). Component 2 (124) is included as a shortcut within iView 1 (116), the shortcut indicating the portal providing the content, such as producer portal 2 (112). Consumer portal 1 implements sub-unit 1 (128) and producer portal 2 (112) implements parts such as sub-unit 2 (132) and sub-unit 3 (136). Sub-unit 1 (128) sub-unit 2 (132), and sub-unit 3 (136) cannot be accessed or executed as is, but only when executed from within a unit, when required context, such as user, role,. S group or another context is available. Within iView 1 (116), component 1 (120) is implemented as a local sub-unit, such as sub-unit 1 (128), which is executed by consumer portal 1 (108). Component 2 (124), however, is implemented as a remote sub-unit, such as sub-unit 2 (132). iView 1 (116) therefore points at remote sub-unit 2 (132), thus loosely coupling consumer portal 1 (108) and producer portal 2 (112). iView 1 (116) points at sub-unit 2 (132) using a name following a naming convention or a Universal Resource Locator (URL). The name or URL is parsed by shortcut parser (106), implemented as part of enterprise portal 104, or alternatively as part of any portal such as portal 1 (108) utilizing remote sub-units. Enterprise portal 104 or consumer portal 1 (108) also comprise a connection creator component 107 for creating a connection between consumer portal 1 (108) and producer portal 2 (112), for exchanging requests and responses between the portals. It will be appreciated that changing the implementation of sub-unit 2 ( 132) will change tie appearance or behavior for all portals and units pointing at sub-unit 2 (132), such as consumer portal 1 (108), iView 1 (116) and others. On the other hand, iView 1 (116) can be changed to include an additional pointing at sub-unit 3 (134), or the name or URL of component 2 (124) can be changed to point at sub-unit 3 (134) instead of at sub-unit 2 (132). Neither adding a pointing at another sub-unit, or changing the pointing at sub-unit 2 (132) will change the way sub-unit 2 (132) is used by other portals or units pointing at sub-unit 2 (132). It will be appreciated by a person skilled ion the art that the disclosure can be applied to transitive usage. Thus, another producer portal 3 (144) can be used, wherein sub-unit 2 (132) of producer portal 2 (112) uses the contents of sub-unit 4 (148) of producer portal 3 (144), such that consumer portal 1 (108) presents content from a third portal via a second portal.

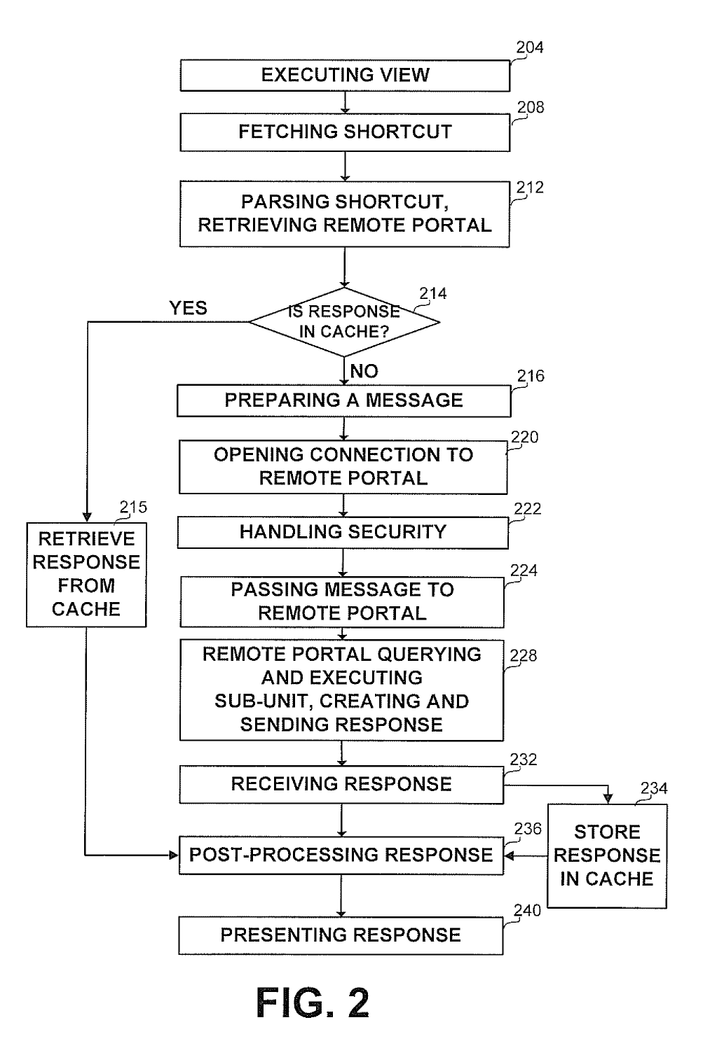

Referring now to FIG. 2, showing the main steps in a method for creating loose coupling between portals. The method starts, for example, when a user using a client computing platform such as client 1 (140) requests to access a portal, such as portal 1 (108).

On step 204 a portal, such as consumer portal 1 (108) of FIG. 1 is executing a unit, such as View 1 (116). As part of the view execution, a shortcut is fetched on step 208. The shortcut possibly contains a predetermined string indicating that the shortcut relates to another portal, or any other naming convention.

On step 212 the shortcut is parsed, either by portal 1 (108), or by enterprise portal (104), and the remote portal such as producer portal 2 (112) and the location from which the content is to be retrieved is extracted or otherwise retrieved. The portal and the required sub-unit of the portal are optionally retrieved using any tool for retrieving location, such as Java Naming and Directory Interface (JNDI), which is an Abstract Program Interface (API) for directory service, that allows clients to discover and lookup data and objects via a name.

On step 214, it is determined whether the required response is available to portal 1 from a cache memory, in which it has been stored before. If the response is available from the cache, the response is retrieved from the cache on step 215. On step 216 a message comprising the request to portal 2 (112) is prepared. The message can be a TCP message or a UDP message or a derivative thereof, for example a SOAP message, RPC message, RMI message, or another protocol preferably over HTTP or HTTPS. The request can be a predetermined request, or comprise information retrieved from the first portal.

On step 220 a connection, preferably a TCP connection or a UDP connection or a derivative thereof such as a SOAP connection, an RMI connection, or an RPC connection is opened between portal 1 (108) and portal 2 (112). On step 222 security is handled, in order to determine a secure protocol for communication between the servers, according to the configurations of the servers, including factors such as user credentials. SSO ticket, or a protocol such as X509, SAML, or the like. On step 224 the message, preferably a TCP message or a UDP message, such as the SOAP, RMI, HTTP, HTTP, or HTTPS message, is passed to the remote portal, such as portal 2 (112).

On step 228 the remote portal queries and executes the sub-unit, constructs a serialized response, preferably a TCP response or a UDP response, such as a SOAP, RMI, RPC, HTTP or HTTPS response, and sends the response back to the local portal, such as portal 1 (108). The sub-unit is executed using information fetched via a local lookup mechanism such as the Portal Content Directory (PCD) lookup or a remote lookup.

On step 232 the local portal receives the response as sent from the remote portal. If the response is not already in the cache, and subject to determining whether it should be stored in cache memory, the response is stored in a cache memory. On step 236 the local portal post-processes the response, including activities such as de-serializing the response, providing local context, branding the response according to the local server, or other activities.

On step 240 the local portal presents the response as part of the executed unit. The object as created by the remote portal and post-processed and presented by the local portal may contain only partial information about the sub-unit. If required, the process is repeated with additional requests for more data and corresponding responses. Thus, the executed unit, such as view 1 (116), is oblivious to where the addressed components, such as local component 1 (120) and component 2 (124) are executed.

It will be appreciated that if a portal is to retrieve content indirectly from a third portal via a second portal, than the steps of fetching a shortcut, parsing the shortcut, opening a connection, sending a request and receiving response are repeated between the second portal and the third portal.

The disclosed method and apparatus connect portals in a transparent way, and enables loose coupling between portals. The disclosed method and apparatus enable dynamic content re-usage and saving on resources, through the execution of sub-units outside the context of a particular unit. The disclosed method and apparatus further enable the execution of a sub-unit of portal 2 (112) from the context of a unit of portal 1 (108), such as view 1 (116).

It will be appreciated by a person skilled in the art that the disclosed method and apparatus can also be used in a transitive manner, i.e., enabling a first portal to use dynamic content from a second portal, which in turn uses dynamic content from a third portal.

It will be appreciated by a person skilled in the art that the disclosed method can also be performed using direct access rather than via an enterprise portal, by adapting a browser or another application used by a user of a client machine, such as client 1 (140).

It will be appreciated by a person skilled in the art that multiple variations and options can be designed along the guidelines of the disclosed method.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this invention, but only by the claims that follow.

1. A method for utilizing within a first portal, content from a second portal in a portal environment, the method comprising:
fetching from the first portal a shortcut associated with the second portal;
parsing the shortcut to retrieve the second portal and the content location;
opening a connection between the first portal and the second portal;
sending a request to the second portal via the connection;
receiving a response from the second portal, the response associated with the content; and
presenting data retrieved from the response.

2. The method of claim 1 further comprising a step of preparing the request to be sent to the second portal.

3. The method of claim 1 further comprising the steps of:
executing a part of the second portal to retrieve the content;
preparing the response associated with the content; and
sending the response to the first portal.

4. The method of claim 1 further comprising a step of post-processing the response.

5. The method of claim 4 wherein post processing comprises deserializing the response.

6. The method of claim 1 wherein the response is a TCP or UDP response.

7. The method of claim 1 wherein the response is an HTTP response, an HTTPs response, RMI response, RPC response, or a SOAP response.

8. The method of claim 1 wherein the first portal presents the data as part of an executable unit.

9. The method of claim 1 further comprising a caching step for storing the response in cache memory.

10. The method of claim 9 further comprising a step of determining whether the response is available in cache memory.

11. The method of claim 1 further comprising a security handling step for determining secure protocol for communication between the a first computing platform executing the first portal and a second computing platform executing the second portal.

12. The method of claim 1 wherein the response is prepared by the second portal using the steps of:
fetching from the second portal a shortcut associated with a third portal;
parsing the shortcut to retrieve the third portal and the content location;
opening a second connection between the second portal and the third portal;
sending a request to the third portal via the second connection; and
receiving a response from the third portal, the response associated with the content.

13. An apparatus for utilizing within a first portal, content from a second portal, the apparatus comprising:
within the second portal a part providing the content;
within the first portal, an executable unit, the executable unit comprising an indication to the second portal;
a shortcut parser component for parsing the indication to the second portal; and
a connection creator component for creating a connection between the first portal and the second portal for sending and receiving requests and responses related to the content.

14. The apparatus of claim 13 wherein the connection is a TCP connection or a UDP connection.

15. The apparatus of claim 13 wherein the connection is an RMI connection, an RPC connection, or a SOAP connection.

16. Within a first portal, an indication to a component of a second portal, the indication being a shortcut indicating the second portal, the component providing content to be displayed by the first portal.

17. A computer readable storage medium containing a set of instructions for a general purpose computer, the set of instructions comprising:
fetching from a first portal a shortcut associated with content to be displayed by the first portal;
parsing the shortcut to retrieve a second portal and the content location;
opening a connection between the first portal and the second portal;
sending a request to the second portal via the connection;
receiving a response from the second portal, the response associated with the content; and
presenting data retrieved from the response.
